(19) United States
(12) Patent Application Publication
(10) Pub. No.: US 2017/0163988 A1
(43) Pub. Date: Jun. 8, 2017

(54) SYSTEMS AND METHOD OF USING COMPRESSED REFERENCE FRAMES IN VIDEO CODECS

(71) Applicant: Samsung Display Co., Ltd., Yongin-si (KR)

(72) Inventors: Ning Lu, Saratoga, CA (US); Dale F. Stolitzka, Los Altos, CA (US)

(21) Appl. No.: 15/344,444

(22) Filed: Nov. 4, 2016

Related U.S. Application Data
(60) Provisional application No. 62/264,757, filed on Dec. 8, 2015.

(51) Int. Cl. H04N 19/159; H04N 19/15; H04N 19/107; H04N 19/124; H04N 19/13; H04N 19/105; H04N 19/61

(52) U.S. Cl. CPC H04N 19/159; H04N 19/105; H04N 19/15; H04N 19/61; H04N 19/124; H04N 19/13; H04N 19/107; H04N 19/172

(57) ABSTRACT

A video encoder includes: a coded data generator configured to receive an original frame and one or more reference frames, and to generate coded data utilizing the original frame and the one or more reference frames; and a reference frame generator configured to receive one or more decoded reference frames, and compressing and decompressing the one or more decoded reference frames to provide the one or more reference frames to the coded data generator.

### CROSS-REFERENCE TO RELATED APPLICATION

This utility patent application claims priority to and the benefit of U.S. Provisional Patent Application Ser. No. 62/264,757, filed Dec. 8, 2015, entitled “SYSTEMS AND METHOD OF USING COMPRESSED REFERENCE FRAMES IN VIDEO CODECS” the entire content of which is incorporated by reference herein.

### BACKGROUND

In video data distribution, data bandwidth has always been an important consideration. From on-line video streaming to high quality movie delivery, the race between the growth of communication bandwidth and the increase of display resolution puts even more requirements on video data compression.

For example, the data compression scheme should provide high compression ratio and high visual quality, while also providing low implementation cost and low latency.

One way to achieve lower implementation cost is to reduce or minimize memory requirements. However, increases to frame resolution are making the cost of storing the temporal reference frames very high. Further, advanced video codecs utilize an increasing number of reference frames.

The above information disclosed in this Background section is only to enhance the understanding of the background of the disclosure, and therefore it may contain information that does not constitute prior art.

### SUMMARY

According to some example embodiments of the present invention, systems and methods are provided to store reference frames in compressed formats, so as to reduce the reference frame buffer size.

According to some example embodiments of the present invention, decoded images (e.g., images that are first intra encoded then intra decoded) are used for encoding, and the same process is replicated at the decoder end so that identical or substantially identical decoded images are used for encoding at the encoder end and for decoding at the decoder end. For example, instead of using previously decoded image frames, newly decoded image frames of re-encoded reference frames may be used as reference frames.

According to some example embodiments of the present invention, predicted frames are used as reference frames. In other words, a previously decoded frame may be used as both a reference frame, which is used to decode other frames, and as a predicted frame, which is used to generate a display frame.

Example embodiments according to the present invention may be applicable to all suitable video codecs that use reference frames, including the standard ones of MPEG-2, H.264 (AVC), and H.265 (HEVC). Example embodiments may provide an addition or extension to any suitable existing compression technologies.

According to some example embodiments of the present invention, transformation is applied prior to encoding. This way, compression is performed on transformation coefficients instead of on pixels.

According to some example embodiments of the present invention, the coefficients are encoded in bit-planes (e.g., from the most significant bit to the least significant bit) instead of using quantization. This may be equivalent to using powers of 2 as quantizers. This way, rather than quantizing and transmitting the entire value, bit planes corresponding to upper significant bits (i.e., sequentially starting with the most significant bit) may be transmitted.

According to some example embodiments of the present invention, image regions of the predicted frame are periodically set to constant gray (e.g., flat or zero values) in turn, which is equivalent to inserting intra-coded image regions as intra refresh, as long as both the encoder and the decoder follow the same rule. In other words, a uniform gray picture (e.g., a picture having uniformly identical gray values, such as flat or zero values) may be used as a reference frame.

According to some example embodiments of the present invention, a video encoder includes: a coded data generator configured to receive an original frame and one or more reference frames, and to generate coded data utilizing the original frame and the one or more reference frames; and a reference frame generator configured to receive one or more decoded frames, and to compress and decompress the one or more decoded frames to provide as the one or more reference frames to the coded data generator.

The compressing and decompressing the one or more decoded frames may include intra encoding and intra decoding the one or more decoded frames.

The reference frame generator may include an intra encoder configured to encode the one or more decoded frames, and an intra decoder configured to decode the one or more decoded frames encoded by the intra encoder.

The compressed and decompressed one or more decoded frames may be utilized as both a predicted frame and the one or more reference frames.

The coded data generator may include a transformation coefficients generator configured to receive the original frame to generate residual coefficients instead of calculating a difference between the original frame and a predicted frame.

The coded data generator may further include a quantizer to generate quantized values of the residual coefficients or a bitplane scanner to generate bitplanes of the residual coefficients.

The coded data generator may include a transformation coefficients generator to generate transformation coefficients corresponding to the original frame, and at least one of a quantizer to generate quantized values of the transformation coefficients, or a bitplane scanner to generate bitplanes of the transformation coefficients.

The video encoder may be configured to refresh an entire screen with intra-coded blocks periodically.

In another example embodiment according to the present invention, a video decoder includes: an image frame generator configured to receive coded data, and to generate an image frame using the coded data; and a video compressor configured to receive the image frame, and to compress and decompress the image frame to generate the display frame.

The video decoder may further include a frame buffer memory configured to store compressed frames, wherein size of the frame buffer memory is less than that would be required to store a number of frames that is the same as a number of the compressed frames.

The video compressor may include an intra encoder to compress the image frame, and an intra decoder to decompress the compressed image frame.

The video decoder may further include a frame buffer memory configured to store the compressed image frame and a compressed reference frame.

The video decoder may further include a bitplane converter configured to convert residual in bitplanes to residual coefficients.

The video decoder may further include a frame buffer memory configured to receive coded intra coefficients, and to generate a display frame using the coded intra coefficients.

The frame buffer memory may include an intra decoder to decode the coded intra coefficients, and an inverse transformer to generate the display frame utilizing the decoded intra coefficients.

In another example embodiment according to the present invention, a video display system includes: an encoder configured to transform an original pixel frame to generate transform coefficients prior to encoding; and a decoder configured to inverse transform decoded coefficients immediately prior to displaying to generate a display frame.

The encoder may include a coefficients compressor configured to receive decoded residual coefficients, and to generate decoded coefficients.

The coefficients compressor may include an intra encoder configured to encode the decoded residual coefficients to generate coded intra coefficients, and an intra decoder to decode the coded intra coefficients to generate the decoded coefficients.

The decoder may include a memory configured to store the decoded coefficients.

The memory may include an intra decoder to receive coded intra coefficients and to decode the coded intra coefficients to generate the decoded coefficients, and an inverse transformer to receive the decoded coefficients and to inverse transform the decoded coefficients to generate the display frame.

By combining one or more example embodiments and/or features thereof, a more compact decoding system may be realized.

### BRIEF DESCRIPTION OF THE DRAWINGS

The above and other aspects and features of the present invention will become more apparent to those skilled in the art from the following detailed description of the example embodiments with reference to the accompanying drawings.

FIG. 1 is a schematic diagram illustrating video encoding according to related art.

FIG. 2 is a schematic diagram illustrating video decoding according to related art.

FIG. 3 is a schematic diagram of a video encoding/decoding system according to example embodiments of the present invention.

FIG. 4 is a schematic diagram illustrating video encoding according to example embodiments of the present invention.

FIG. 5 is a schematic diagram illustrating video decoding according to example embodiments of the present invention.

FIG. 6 is a schematic diagram illustrating video encoding according to other example embodiments of the present invention.

FIG. 7 is a schematic diagram illustrating video decoding according to other example embodiments of the present invention.

### DETAILED DESCRIPTION

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

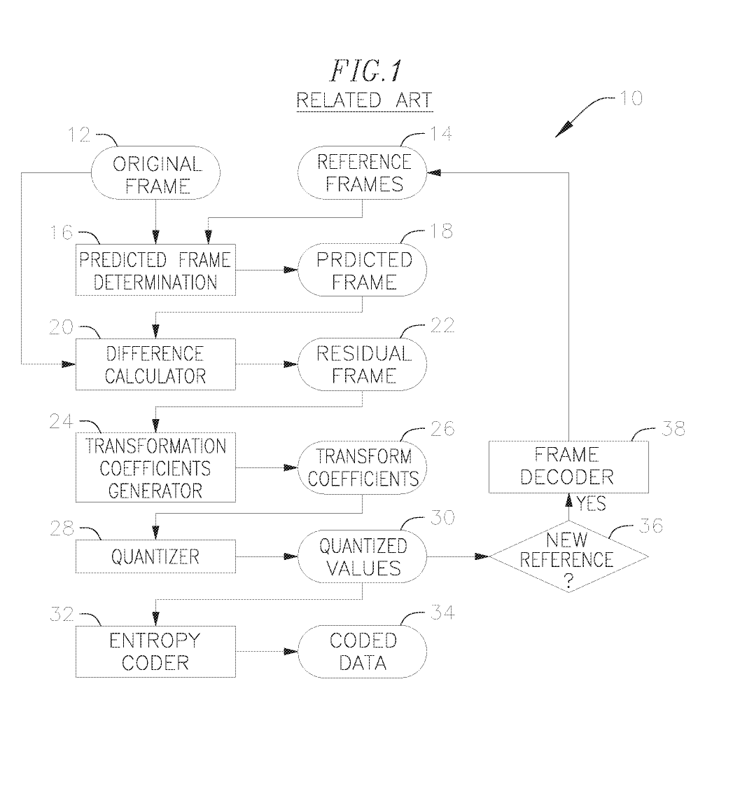

FIG. 1 is a schematic diagram illustrating video encoding in an encoder 10 according to related art. The encoder 10 includes a predicted frame determiner 16, a difference calculator 20, a transformation coefficients generator 24, a quantizer 28, an entropy coder 32, and a frame decoder 38.

In the encoder 10, an original frame 12 and one or more reference frames 14 are provided to the predicted frame determiner 16 to determine a predicted frame 18. Then a difference between the original frame 12 and the predicted frame 18 is obtained by the difference calculator 20 to generate a residual frame 22. The residual frame 22 is provided to the transformation coefficients generator 24 to generate transformation coefficients 26, which are quantized by the quantizer 28 to generate quantized values 30.

The quantized values 30 are provided to the entropy coder 32 to generate coded data 34. Therefore, the coded data 34 include residues (or a residual frame) that have been transformed to generate transformation coefficients, quantized, and entropy-coded. The quantized values 30 are also provided to the frame decoder 38 to generate a new reference frame (or reference frames) when it is determined (36) that a new reference frame should be used for encoding.

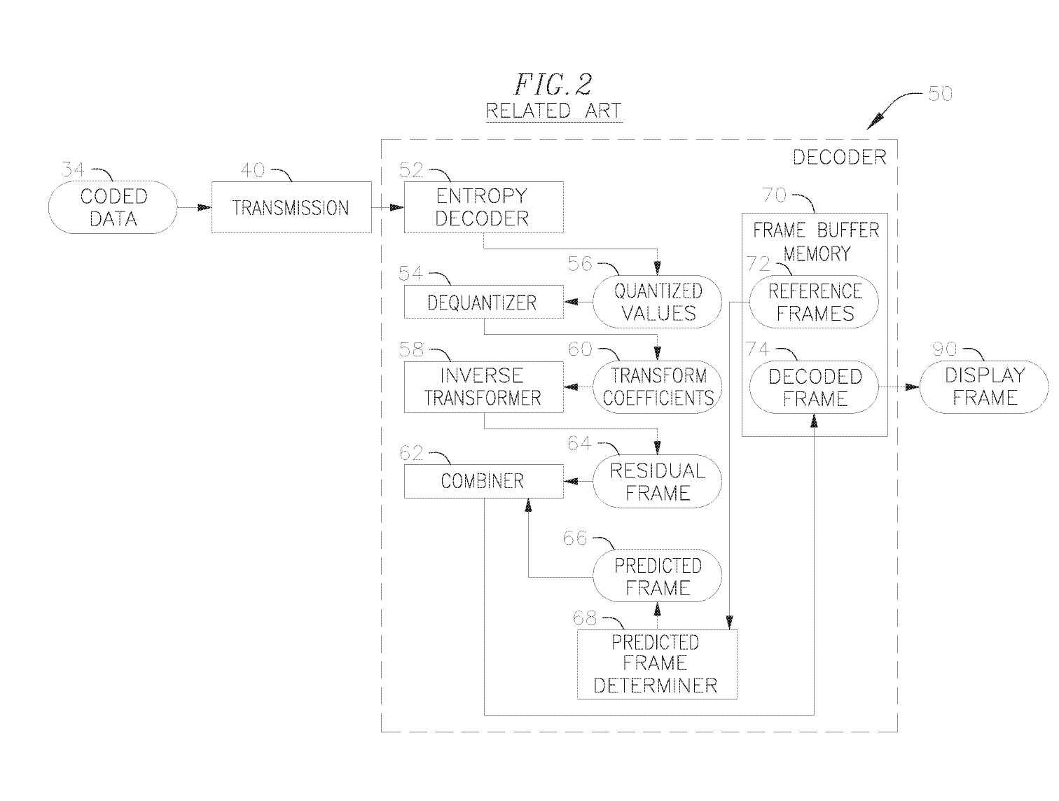

FIG. 2 is a schematic diagram illustrating video decoding in a decoder 50 according to related art. The coded data 34 (e.g., from the encoder 10 of FIG. 1) is provided to the decoder 50 through a transmission medium 40.

The decoder 50 includes an entropy decoder 52, a dequantizer 54, an inverse transformer 58, a combiner 62, a predicted frame determiner 68, and a frame buffer memory 70.

The coded data 34 is first entropy-decoded by the entropy decoder 52 in the decoder 50 to recover quantized values 56, which are de-quantized by the dequantizer 54 to recover transformation coefficients 60. The transformation coefficients 60 are inverse transformed by the inverse transformer 58 to recover a residual frame 64. The residual frame 64 is combined with a predicted frame 66 by the combiner 62 to generate a decoded frame 74. The predicted frame 66 is determined by the predicted frame determiner 68 using one or more reference frames 72. The decoded frame 74 and the one or more reference frames 72 are stored in the frame buffer memory 70. The decoded frame 74 is then provided as a display frame 90.

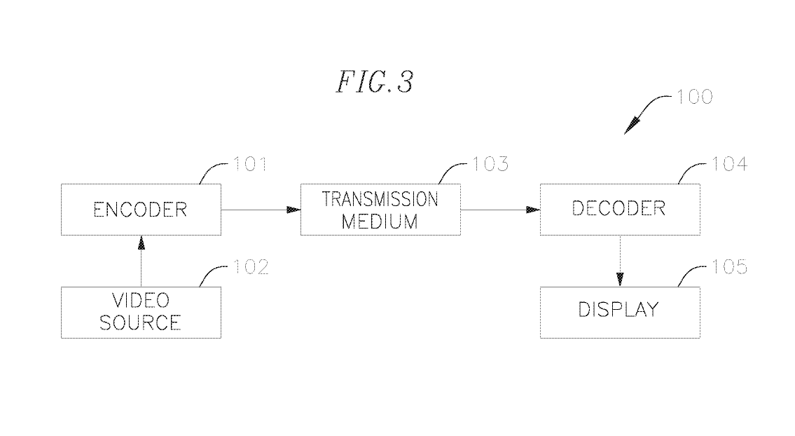

As can be seen in FIG. 3, according to example embodiments of the present invention, an encoding/decoding system 100 includes an encoder 101, which encodes video provided by a video source 102, and transmits encoded video data through a transmission medium 103, which may include one more communication networks having bandwidth that may be limited. The encoded video data is received by a decoder 104 to recover the video data that is then provided to a display 105 to be displayed. According to some embodiments of the present invention, the display 105 may be incorporated into any suitable display device or computer system, such as a personal computer, tablet or touch screen computer system, mobile telephone, smart phone, and the like.

The electronic or electric devices and/or any other relevant devices or components according to embodiments of the present invention described herein, such as, for example, the encoder 101 and the decoder 104 or any other encoders and/or decoders, and any and all components included therein, may be implemented utilizing any suitable hardware, firmware (e.g., an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present invention.

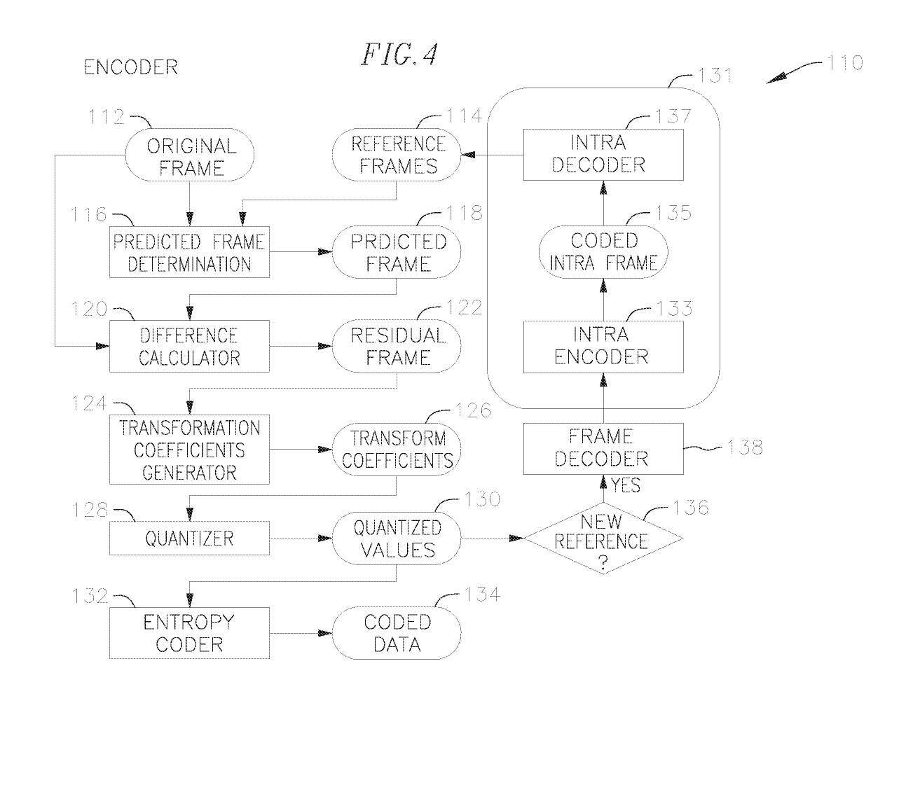

FIG. 4 is a schematic diagram illustrating video encoding in an encoder (or video encoder) 110 according to example embodiments of the present invention. The encoder 110 includes a predicted frame determiner 116, a difference calculator 120, a transformation coefficients generator (or a transformer) 124, a quantizer 128, an entropy coder 132, a frame decoder 138, and a reference frame generator 131. The reference frame generator 131 includes an intra encoder 133 and an intra decoder 137. Two or more of the predicted frame determiner 116, a difference calculator 120, a transformation coefficients generator 124, a quantizer 128, and an entropy coder 132 may together be referred to herein as a coded data generator.

In the encoder 110, an original frame 112 and a reference frame (or reference frames depending on the prediction type) 114 are provided to the predicted frame determiner 116 to determine a predicted frame 118. In some example embodiments, the original frame 112 may not be provided to the predicted frame determiner 116. At the beginning the reference frame 114 may be assumed to be flat (e.g., a frame having zero or uniform gray values). So the first frame being decoded is essentially intra-coded because the reference frame is flat.

The predicted frame 118 may be the re-encoded and decoded frame (e.g., in the reference frame generator 131), which is the reference frame (or multiple reference frames) 114, or it may be a flat frame. For inter-coding, the predicted frame 118 is the reference frame (or multiple reference frames) 114. For intra-coding, the predicted frame 118 is the flat frame (e.g., all pixels having zero values or constant/uniform gray values). Hence, the prediction done by the predicted frame determiner 116 is a determination on whether or not to use the reference frame, such that the reference frame or the flat frame is copied and used for encoding.

Then the difference calculator 120 obtains a difference between the original frame 112 and the predicted frame 118 to generate a residual frame 122. Because the residual frame 122 represents the difference between the original frame 112 and the predicted frame 118, in the case of the intra-coding, the original frame 112 becomes the residual frame 122.

The residual frame 122 is then provided to the transformation coefficients generator 124 to generate transformation coefficients 126, which are quantized by the quantizer 128 to generate quantized values 130. The transformation coefficients generator uses any suitable transformation method, algorithm and/or device known to those skilled in the art to generate the transformation coefficients. For example the transformation coefficients generator 124 may use wavelet transformation, discrete cosine transformation (DCT) and/or the like to generate the transformation coefficients.

The quantized values 130 are provided to the entropy coder 132 to generate coded data 134. For instance, as those skilled in the art would appreciate, entropy coding is a type of lossless coding to compress digital data by representing more frequently occurring patterns with fewer bits than those patterns that occur with less frequency. The entropy coder 132 may use any suitable entropy coding type, methodology and/or algorithm that is known to those skilled in the art. After the entropy coding, the coded data 134 include residues (or a residual frame) that have been transformed, quantized, and entropy-coded.

The quantized values are also provided to the frame decoder 138 to determine a new reference frame (or reference frames) when it is determined (136) that a new reference frame should be used. Here, the intra/inter coding determination may be made by the encoder 110 based on which coding type gives better quality. Most times, inter-coding, which uses a difference between the current image and adjacent image(s) or the reference image, may be preferable or more suitable than intra-coding. When the difference between the images is that significant, for example, there are no changes, inter-coding may be more suitable. However, when scenes change too much, intra-coding may be preferable than inter-coding.

In example embodiments according to the present invention, the encoder 110 is forced or programmed to use intra-coding once in a while because errors may be introduced and propagated when inter-coding is used. By using intra-coding from time to time, the coding mechanism is refreshed. According to some example embodiments, intra blocks are used (or send) gradually, such that, for example, the entire screen may be refreshed every few seconds. When intra-coding is used, any previous errors disappear. The intra blocks are spread out over time because intra-coding should typically not be used all the time.

In some example embodiments, for example, the determination to use a new reference frame may also be made when it is determined that the difference between the current frame and the existing reference is substantial or significant (e.g., more than a set threshold or limit), which those skilled in the art would appreciate.

According to example embodiments of the present invention, the one or more reference frames 114 are generated by the reference frame generator 131. The intra encoder 133 in the reference frame generator 131 are used to intra code the one or more reference frames decoded by the decoder 138 to generate coded intra frames 135. The coded intra frames 135 are then intra decoded by the intra decoder 137 in the reference frame generator 131 to recover the one or more reference frames 114. By using decoded images (e.g., images that are first intra encoded then intra decoded) for encoding, and replicating the same process at the decoder end, identical or substantially identical decoded images maybe used for encoding at the encoder end and for decoding at the decoder end. For example, instead of using previously decoded image frames, newly decoded image frames of re-encoded reference frames may be used as reference frames.

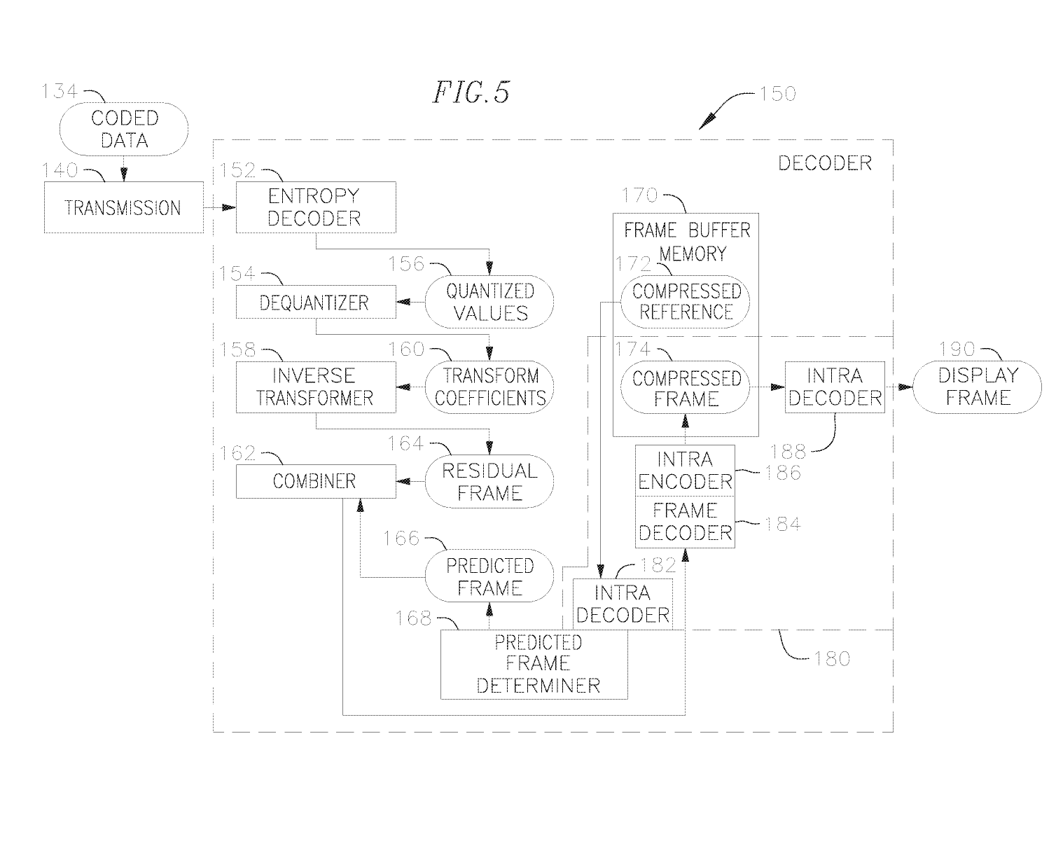

In other words, by intra encoding and subsequently intra decoding the one or more reference frames decoded by the frame decoder 138, the encoding/decoding system according to embodiments of the present invention ensures that the one or more reference frames used by the encoder 110 are identical or substantially identical to the one or more references frames used by a decoder (e.g., a decoder 150 of FIG. 5).

FIG. 5 is a schematic diagram illustrating video decoding in the decoder (or video decoder) 150 according to example embodiments of the present invention. The decoder 150 includes an entropy decoder 152, a dequantizer 154, an inverse transformer 158, a combiner 162, a predicted frame determiner 168, and a frame compressor 180. The frame compressor 180 includes an intra decoder 182, a frame decoder 184, an intra encoder 186, an intra decoder 188, and a frame buffer memory 170. Two or more of the entropy decoder 152, the dequantizer 154, the inverse transformer 158, the combiner 162, and the predicted frame determiner 168 may together be referred to herein as an image frame generator (or a decoded frame generator).

The coded data 134 is provided to the decoder 150 through a transmission medium 140. The transmission medium 140 may include one or more communications networks and has a bandwidth that is limited by factors such as the type of network, devices on the network, and/or the like.

The entropy decoder 152 first entropy-decodes the coded data 134 to recover quantized values 156. The entropy decoder 152 uses the same or corresponding entropy coding type, methodology and/or algorithm as the one that is used by the entropy coder 132 of FIG. 4, as those skilled in the art would appreciate.

The dequantizer 154 de-quantizes the quantized values 156 to recover transformation coefficients 160. The inverse transformer 158 then transforms the transformation coefficients 160 to recover a residual frame (or residues) 164. The combiner 162 combines the residual frame 164 with a predicted frame 166 to generate a combined frame, which is the predicted frame and/or the reference frame.

The predicted frame determiner 168 makes a determination as to what frame or frames should be combined with the residual frames 164 to generate the predicted frames. For residual frames generated using intra-coding, the frame used by the combiner 162 may be a flat frame (e.g., frame with zero values or constant/uniform gray values). Further, for residual frames generated using inter-coding, the frame used by the combiner 162 may be one or more reference frames.

According to example embodiments, the intra decoder 182 generates the one or more reference frames using one or more compressed reference frames 172 stored in the frame buffer memory 170. The frame buffer memory 170 stores the one or more compressed reference frames 172 and a compressed frame 174. The one or more reference frames from the intra decoder 182 may then be transmitted to/received by the predicted frame determiner 168 for determination of the predicted frame.

The frame decoder 184 decodes the combined frame (e.g., the predicted frame and/or the reference frame) generated by the combiner 162. The output of the frame decoder 184 is in uncompressed form, then is compressed by the intra encoder 186 (which may also be referred to as a compressor) used by the system for frame buffer compression. In some embodiments, the frame decoder 184 may not be necessary or used. The intra encoder 186 intra encodes the decoded combined frame to generate the compressed frame 174. Then the intra decoder 188 intra-decodes the compressed frame 174 to generate a display frame 190 to be displayed. This way, the process of using decoded images (e.g., images that are first intra encoded then intra decoded) for encoding in the encoder 110 of FIG. 4 is substantially replicated in the decoder 150 so that identical or substantially identical decoded images are used for encoding at the encoder end and for decoding at the decoder end.

Therefore, in example embodiments according to the present invention, the decoder 150 includes the frame compressor 180 including the intra decoder 182, the frame decoder 184, the intra encoder 186 and the intra decoder 188 to compress reference and display frames that are stored in the frame buffer memory 170. This way, the size of the frame buffer memory 170, which may be implemented using SRAM, may be reduced (in comparison to the frame buffer memory in conventional decoders that store entire frame images) or minimized. For example, the compression ratio of the frame buffer memory 170 may be fixed, and the ratio may be 2:1, 3:1 or 4:1 according to example embodiments.

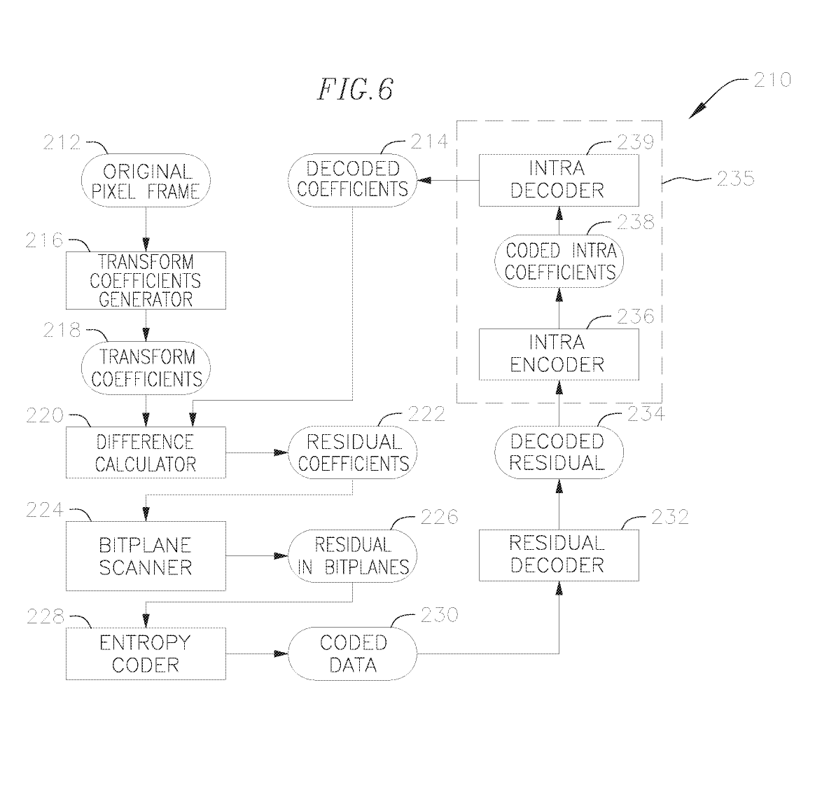

An encoder (or video encoder) 210 of FIG. 6 includes features of one or more embodiments according to the present invention. The encoder 210 includes a transformation coefficients generator 216, a difference calculator 220, a bitplane scanner 224, an entropy coder 228, a residual decoder 232 and a coefficients compressor 235. The coefficients compressor 235 includes an intra encoder 236 and an intra decoder 239.

The encoder 210 first receives an original pixel frame (or an original frame) 212. The transformation coefficients generator 216 transforms the original pixel frame 212 to generate transformation coefficients 218. Hence, in example embodiments, the transformation is applied at the beginning before encoding, and the inverse transformation is used right before the display. This way, the encoding can be done at a transformed domain. This way, when decoding is done, decoding does not need to be done all the way to the pixels because the decoding can also be done at the transformed domain. This way, inverse transformation is not required when storing re-encoded intra coefficients (or coded intra coefficients) in a frame buffer memory at the decoder end.

The difference calculator 220 receives the transformation coefficients 218 and decoded coefficients 214 (from the intra decoder 239) to generate residual coefficients 222. The difference calculator 220 obtains a difference between the transformation coefficients 218 and the decoded coefficients 214 to generate the residual coefficients 222. Therefore, when the original pixel frame (or the transformation coefficients thereof) is to be intra-coded, the decoded coefficients 214 would not affect the values of the residual coefficients 222, such that the residual coefficients 222 would be identical or substantially identical to the transformation coefficients 218.

The bitplane scanner 224 receives the residual coefficients 222 to generate residual in bitplanes 226. The bitplane scanner 224 generates bitplanes corresponding to the images. For example, the bitplane corresponding to the most significant bit would include 1's and 0's corresponding to the most significant bit throughout the entire image.

Those skilled in the art would appreciate that a number (e.g., a gray level) can typically be expressed in a binary form. For example, the number 100 can be written as having an weight at 64, 32, and 4 bit positions. So the number 100 can be written in 7 bits as 1100100 from the most significant bit to the least significant bit. Here, each digit of the binary number can be viewed as being on its own bitplane. For example when a binary number is divided by 2, the position of the bits is shifted by one to the right, and only 6 bits (110010) may be used or sent, and when a binary number is divided by 4, the position of the bits is shifted by two to the right, and only 5 bits (11001) may be used or sent.

Sometimes dividing by 2 might be too little, but dividing by 4 might be too much. In some quantization methods, such as when using JPEG, a number can typically be divided by 3 more precisely. However, when bitplanes are used, a division by 3 cannot be performed precisely, because only powers of 2 can be used for the division. Here, when data is to be divided by 2, precise quantization can be performed using bitplanes. However, when data is to be divided by 3, precise quantization cannot be performed using bitplanes, so that a division by 4 may be used. Because the bits are sent in an order from the most significant bit to the least significant bit, quantization division is not necessary, as using bitplanes is equivalent to quantization by the power of 2. When bitplanes are used, upper significant bits are sent but lower significant bits might not be sent and may be ignored, and that's one way of data compression. At the decoder end, the missing bits (e.g., bits that are not sent) may be recreated.

In other example embodiments, a quantizer may be used instead of the bitplane scanner to quantize the residual coefficients and generate quantized values instead of residual in bitplanes.

The entropy coder 228 then entropy codes the residual in bitplanes (or residual bitplanes) 226 to generate coded data 230. The entropy coder 228 may use any suitable entropy coding type, algorithm and/or methodology known to those skilled in the art. The residual decoder 232 receives the coded data to generate a decoded residual 234, which is then intra encoded in the intra encoder 236. The intra encoder 236 generates coded intra coefficients 238, which are then intra decoded by the intra decoder 239 to generate the decoded coefficients 214.

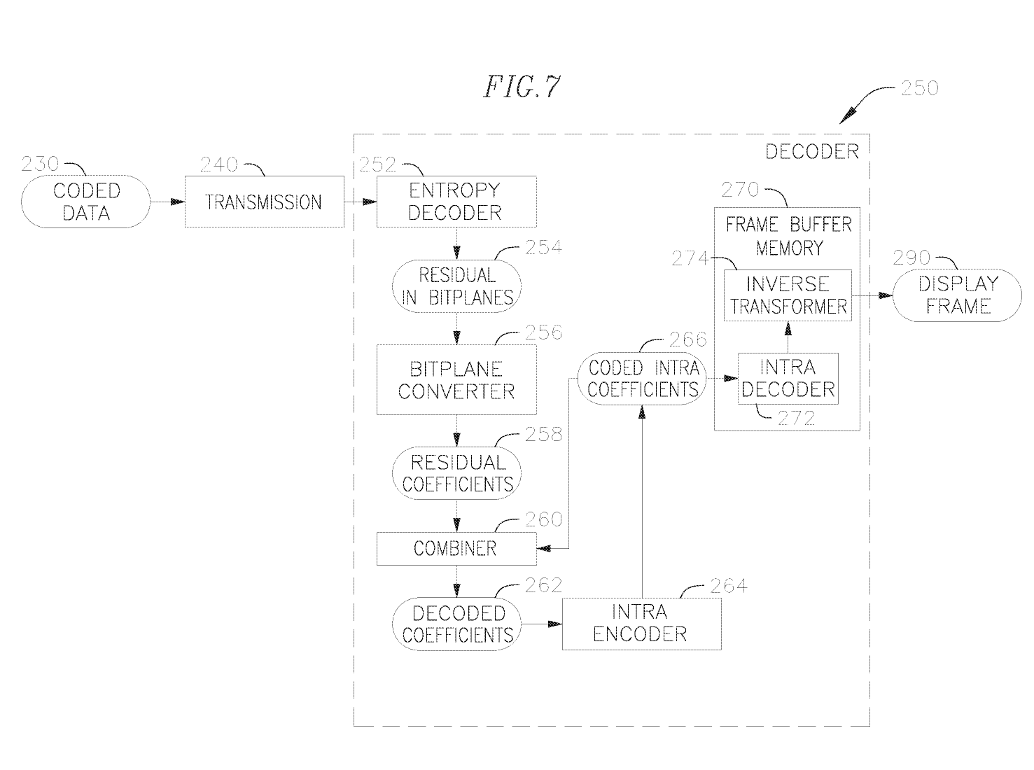

A decoder (or video decoder) 250 of FIG. 7 includes an entropy decoder 252, a bitplane converter 256, a combiner 260, an intra encoder 264, and a frame buffer memory 270.

The decoder 250 receives the coded data 230 through a transmission medium 240. The transmission medium 240 may include one or more of communications networks, and may have a set or limited bandwidth. The entropy decoder 252 decodes the coded data 230 to recover a residual in bitplanes 254. To decode the coded data 230 (e.g., the coded data 230 generated in the encoder of FIG. 6), the entropy decoder uses the same or corresponding entropy coding type, methodology and/or algorithm as the entropy coder 228 of FIG. 6, as those skilled in the art would appreciate.

The bitplane converter 256 converts the residual in bitplanes 254 into residual coefficients 258. For example, the bitplane converter 256 recovers the residual coefficients 258 by combining bit values corresponding to each pixel in the residual bitplanes. The combiner 260 combines the residual coefficients 258 with coded intra coefficients 266 to generate decoded coefficients 262. The intra encoder 264 intra encodes the decoded coefficients 262 to generate the coded intra coefficients 266.

The coded intra coefficients 266 are also provided to and stored in the frame buffer memory 270. In the frame buffer memory 270, the intra decoder 272 intra-decodes the coded intra coefficients 266. The decoded intra coefficients are then provided to the inverse transformer 274 to generate a display frame 290. By storing the coded intra coefficients that are compressed rather than entire frames in the frame buffer memory 270, the amount of memory (e.g., SRAM) required by the decoder 250 may be minimized or reduced in comparison to conventional decoders that store entire frame images. Further, inverse transformation may be performed once right before the display to generate the display frame 290.

Although the present invention has been described with reference to the example embodiments, those skilled in the art will recognize that various changes and modifications to the described embodiments may be performed, all without departing from the spirit and scope of the present invention. Furthermore, those skilled in the various arts will recognize that the present invention described herein will suggest solutions to other tasks and adaptations for other applications. It is the applicant's intention to cover by the claims herein, all such uses of the present invention, and those changes and modifications which could be made to the example embodiments of the present invention herein chosen for the purpose of disclosure, all without departing from the spirit and scope of the present invention. Thus, the example embodiments of the present invention should be considered in all respects as illustrative and not restrictive, with the spirit and scope of the present invention being indicated by the appended claims, and their equivalents. Further, those skilled in the art would appreciate that one or more features according to one more embodiments of the present invention may be combined with one or more other features according to one or more other embodiments of the present invention without departing from the spirit and scope of the present invention.

What is claimed is:

1. A video encoder comprising:
a coded data generator configured to receive an original frame and one or more reference frames, and to generate coded data utilizing the original frame and the one or more reference frames; and
a reference frame generator configured to receive one or more decoded frames, and to compress and decompress the one or more decoded frames to provide as the one or more reference frames to the coded data generator.

2. The video encoder of claim 1, wherein the compressing and decompressing the one or more decoded frames comprise intra encoding and intra decoding the one or more decoded frames.

3. The video encoder of claim 1, wherein the reference frame generator comprises an intra encoder configured to encode the one or more decoded frames, and an intra decoder configured to decode the one or more decoded frames encoded by the intra encoder.

4. The video encoder of claim 1, wherein the compressed and decompressed one or more decoded frames is utilized as both a predicted frame and the one or more reference frames.

5. The video encoder of claim 1, wherein the coded data generator comprises a transformation coefficients generator configured to receive the original frame to generate residual coefficients instead of calculating a difference between the original frame and a predicted frame.

6. The video encoder of claim 5, wherein the coded data generator further comprises a quantizer to generate quantized values of the residual coefficients or a bitplane scanner to generate bitplanes of the residual coefficients.

7. The video encoder of claim 1, wherein the coded data generator comprises a transformation coefficients generator to generate transformation coefficients corresponding to the original frame, and at least one of a quantizer to generate quantized values of the transformation coefficients, or a bitplane scanner to generate bitplanes of the transformation coefficients.

8. The video encoder of claim 1, wherein the video encoder is configured to refresh an entire screen with intra-coded blocks periodically.

9. A video decoder comprising:
an image frame generator configured to receive coded data, and to generate an image frame using the coded data; and
a video compressor configured to receive the image frame, and to compress and decompress the image frame to generate a display frame.

10. The video decoder of claim 9, further comprising a frame buffer memory configured to store compressed frames, wherein size of the frame buffer memory is less than that would be required to store a number of frames that is the same as a number of the compressed frames.

11. The video decoder of claim 9, wherein the video compressor comprises an intra encoder to compress the image frame, and an intra decoder to decompress the compressed image frame.

12. The video decoder of claim 11, further comprising a frame buffer memory configured to store the compressed image frame and a compressed reference frame.

13. The video decoder of claim 9, further comprising a bitplane converter configured to convert residual in bitplanes to residual coefficients.

14. The video decoder of claim 13, further comprising a frame buffer memory configured to receive coded intra coefficients, and to generate a display frame using the coded intra coefficients.

15. The video decoder of claim 14, wherein the frame buffer memory comprises an intra decoder to decode the coded intra coefficients, and an inverse transformer to generate the display frame utilizing the decoded intra coefficients.

16. A video display system comprising:
an encoder configured to transform an original pixel frame to generate transform coefficients prior to encoding; and
a decoder configured to inverse transform decoded coefficients immediately prior to displaying to generate a display frame.

17. The video display system of claim 16, wherein the encoder comprises a coefficients compressor configured to receive decoded residual coefficients, and to generate decoded coefficients.

18. The video display system of claim 17, wherein the coefficients compressor comprises an intra encoder configured to encode the decoded residual coefficients to generate coded intra coefficients, and an intra decoder to decode the coded intra coefficients to generate the decoded coefficients.

19. The video display system of claim 18, wherein the decoder comprises a memory configured to store the decoded coefficients.

20. The video display system of claim 19, wherein the memory comprises an intra decoder to receive coded intra coefficients and to decode the coded intra coefficients to generate the decoded coefficients, and an inverse transformer to receive the decoded coefficients and to inverse transform the decoded coefficients to generate the display frame.
